(19) United States
(12) Patent Application Publication
(10) Pub. No.: US 2024/0025280 A1
(43) Pub. Date: Jan. 25, 2024

(54) Electric Vehicle Portable Charger Device

(71) Applicant: Ron Foust, Mechanicsburg, PA (US)

(72) Inventor: Ron Foust, Mechanicsburg, PA (US)

(21) Appl. No.: 18/310,666

(22) Filed: May 2, 2023

Related U.S. Application Data
(60) Provisional application No. 63/391,460, filed on Jul. 22, 2022.

(51) Int. Cl. B60L 53/16; B60L 53/53; B60L 53/30; B60L 53/57; B60R 11/00

(52) U.S. Cl. CPC B60L 53/16; B60L 53/53; B60L 53/305; B60L 53/57; B60R 11/00; B60R 2011/004; B60R 2011/0056

(57) ABSTRACT

An electric vehicle portable charger device is described. The device is comprised of a lightweight material and encases a rechargeable battery that can receive and store power via a female charging port. The device can be used as a portable battery to supply power to the battery of an electric vehicle via a male charging port that engages the charging port of the electric vehicle. As a result, the device is capable of supplying power in a portable manner to any electric vehicle.

### CROSS-REFERENCE TO RELATED APPLICATION

The present application claims priority to, and the benefit of, U.S. Provisional Application No. 63/391,460, which was filed on Jul. 22, 2022, and is incorporated herein by reference in its entirety.

### FIELD OF THE INVENTION

The present invention relates generally to the field of electric vehicle charging. More specifically, the present invention relates to an electric vehicle portable charger device. The device is comprised of a lightweight material and encases a rechargeable battery that can store power and supply power to the battery of an electric vehicle. The device is capable of universally supplying power to any charging port of any electric vehicle. Accordingly, the present disclosure makes specific reference thereto. Nonetheless, it is to be appreciated that aspects of the present invention are also equally applicable to other like applications, devices, and methods of manufacture.

### BACKGROUND

Electric vehicles are becoming increasingly popular due to the relatively low amount of emissions they produce and the lack of fossil fuels they consume. However, there is not currently a vast infrastructure in place that allows for an electric vehicle to easily be charged when away from the home. Further, many gas stations lack charging stations for electric vehicles. Accordingly, a vehicle may lose power without a charging station nearby, leaving the passengers of the vehicle stranded.

Therefore, there exists a long-felt need in the art for a device that can charge an electric vehicle while away from the home or a charging station. More specifically, there exists a long-felt need in the art for an electric vehicle portable charging device that can be easily transported by a single person and is capable of supplying power to an electric vehicle. Furthermore, there exists a long-felt need in the art for an electric vehicle portable charging device that can easily be charged and store power for extended periods of time.

The subject matter disclosed and claimed herein, in one embodiment thereof, comprises an electric vehicle portable charger device. The device is comprised of a body, a female charging port, a battery, and a male charging port. The body is preferably made of a plastic or lightweight metal material and is generally rectangular in shape. The battery may be charged prior to driving using an existing electric vehicle charging station charger. Then the device can be used as a portable charging device for an electric vehicle that runs out of charge. The device is preferably capable of supplying power to universally any charging port of any electric vehicle.

In this manner, the electric vehicle portable charger device of the present invention accomplishes all the foregoing objectives and provides a device that can charge an electric vehicle while away from the home or a charging station. More specifically, the electric vehicle portable charging device can store power for long periods of time and use that stored power to charge an electric vehicle. Furthermore, the electric vehicle portable charging device can easily be charged and transported by a single user.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric vehicle portable charger device comprised of a body, a female charging port, a battery, and a male charging port. The device is designed to store and supply electrical power to an electric vehicle when needed. The device is preferably lightweight and rectangular in shape. The body of the device may be easily transported using a handle and may attach to an electric vehicle via at least one fastener.

The body is also comprised of a female charging port. The female port may accept any male charging port (of an EV charging station) to charge at least one rechargeable battery of the device. Then, a male charging port that extends via a charging cord from the body of the device can be inserted into the charging port of an electric vehicle to supply the electric vehicle with power. Further, the male charging port may be of any charging port style to universally connect to the charging port of any electric vehicle.

The present invention is also comprised of a method of using the device. First, a device is provided comprised of providing a device comprised of at least one female charging port, at least one battery, and at least one charger with at least one male charging port. Then, a user can charge the battery of the device by inserting a male EV charger into the female charging port. Then, a user can attach the body of the device to an electric vehicle via the fastener. Next, a user can insert the male charging port of the charger into the charging port of the vehicle and press the button to charge the vehicle.

Accordingly, the electric vehicle portable charger device of the present invention is particularly advantageous as it provides a device capable of charging an electric vehicle away from a charging station or capable household. More specifically, the electric vehicle portable charging device can easily be operated by a single user. Furthermore, the electric vehicle portable charging device can store, for a long period of time, sufficient power to charge an electric vehicle. In this manner, the electric vehicle portable charger device overcomes the limitations of existing electric vehicle chargers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electric vehicle portable charger device of the present invention in accordance with the disclosed architecture;

FIG. 2 illustrates a perspective view of one potential embodiment of an electric vehicle portable charger device of the present invention in accordance with the disclosed architecture;

FIG. 3 illustrates a perspective view of one potential embodiment of an electric vehicle portable charger device of the present invention in accordance with the disclosed architecture;

FIG. 4 illustrates a perspective view of one potential embodiment of an electric vehicle portable charger device of the present invention while being used to charge an electric vehicle in accordance with the disclosed architecture; and

FIG. 5 illustrates a flowchart of a method of using one potential embodiment of an electric vehicle portable charger device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can charge an electric vehicle while away from the home or a charging station. More specifically, there exists a long-felt need in the art for an electric vehicle portable charging device that can be easily transported by a single person and is capable of supplying power to an electric vehicle. Furthermore, there exists a long-felt need in the art for an electric vehicle portable charging device that can easily be charged and store power for extended periods of time.

The present invention, in one exemplary embodiment, is comprised of an electric vehicle portable charger device. The device is comprised of a body, a female charging port, a battery, and a male charging port. The device is designed to store power and then transfer the power to an electric vehicle when the battery of the electric vehicle runs low, and the operator is unable to get the electric vehicle to a charging station or other place in which the electric vehicle may be charged.

More specifically, the device is comprised of a body. The body is preferably made from a plastic or metal material. Said material is lightweight in that it allows the device to be easily transported. The body is preferably rectangular in shape as to distribute the weight of the device evenly and stabilize when placed on a flat surface. The body is further comprised of a battery indicator, a handle, and a fastener. The battery indicator indicates to a user relatively the amount of power that the device is currently storing. The handle allows a user to easily grip and transport the device. The fastener allows the device to attach to the side of an electric vehicle while the device is charging the electric vehicle. Further, the body is comprised of a female charging port that allows the device to take in and store power from a standard wall outlet or other mode of electricity transfer.

The body also contains a battery that is rechargeable and can be used to supply power to an electric vehicle. In addition, extending from the body of the device is a charging cord. The charging cord connects the battery to a charger, which is further comprised of at least one button and a male charging port. The male charging port may supply power to the battery of an electric vehicle such that it may universally attach to the charging port of any electric vehicle. The button of the charger, when activated, allows the user to begin charging the electric vehicle.

The present invention is also comprised of a method of using the device. First, a device is provided comprised of a device comprised of at least one female charging port, at least one battery, and at least one charger with at least one male charging port. Then, a user can charge the battery of the device by inserting a male EV charger into the female charging port. Then, a user can attach the body of the device to an electric vehicle via the fastener. Next, a user can insert the male charging port of the charger into the charging port of the vehicle and press the button to charge the vehicle.

Accordingly, the electric vehicle portable charger device of the present invention is particularly advantageous as it provides a device capable of charging an electric vehicle away from a charging station or capable household. More specifically, the electric vehicle portable charging device can store power for long periods of time, making long road trips more accessible for electric vehicle drivers. Furthermore, the electric vehicle portable charging device is easily transported and can be used by a single person to charge an electric vehicle. In this manner, the electric vehicle portable charger device overcomes the limitations of existing electric vehicle chargers known in the art.

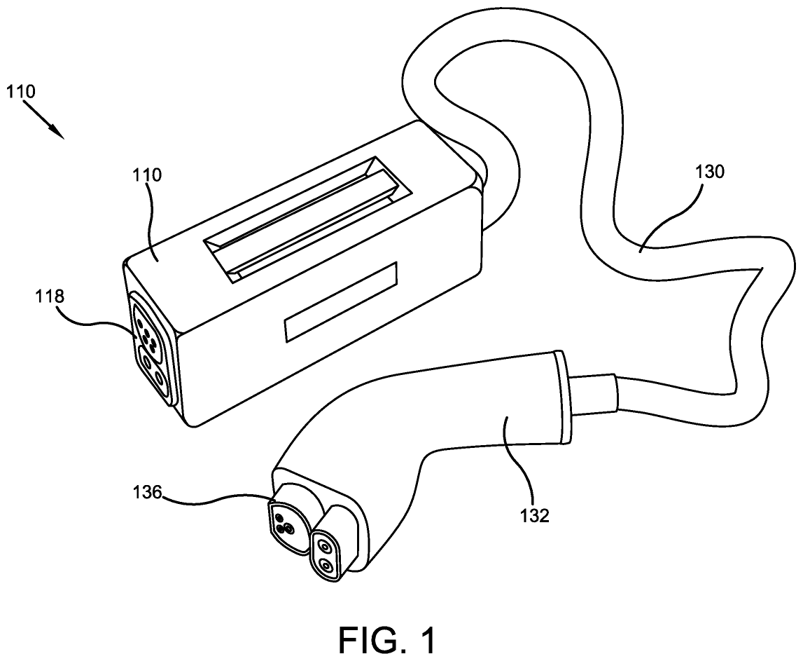

Referring initially to the drawings, FIG. 1 illustrates a perspective view of one potential embodiment of an electric vehicle portable charger device 100 of the present invention in accordance with the disclosed architecture. The device 100 is comprised of a body 110, at least one female charging port 118, at least one battery 120, and a male charging port 136. The device 100 is designed to store power and then transfer that power to an electric vehicle 10 via a male charging port 12.

The body 110 is preferably made from a plastic or metal material that can protect the contents inside of the body 110 as well as keep the device 100 lightweight to be easily portable. The body 110 is preferably rectangular in shape, but may resemble any shape such as, but not limited to: a square, a triangle, a circle, an oval, a pentagon, a hexagon, a cylinder, a prism, etc.

The body 110 is also comprised of a battery indicator 112, a handle 114, and at least one fastener 116. The battery indicator 112 displays the percentage of power (i.e., the amount of charge) remaining in the battery 120 of the device 100. The battery indicator 112, in one potential embodiment, may be an LED screen (or any other display screen of the like) with a bar that decreases in length as the power stored in the device 100 decreases. In differing embodiments, the battery indicator 112 may be numbers, dots, multiple bars, quadrants, or any other means of communicating to a user the relative charge of the device 100.

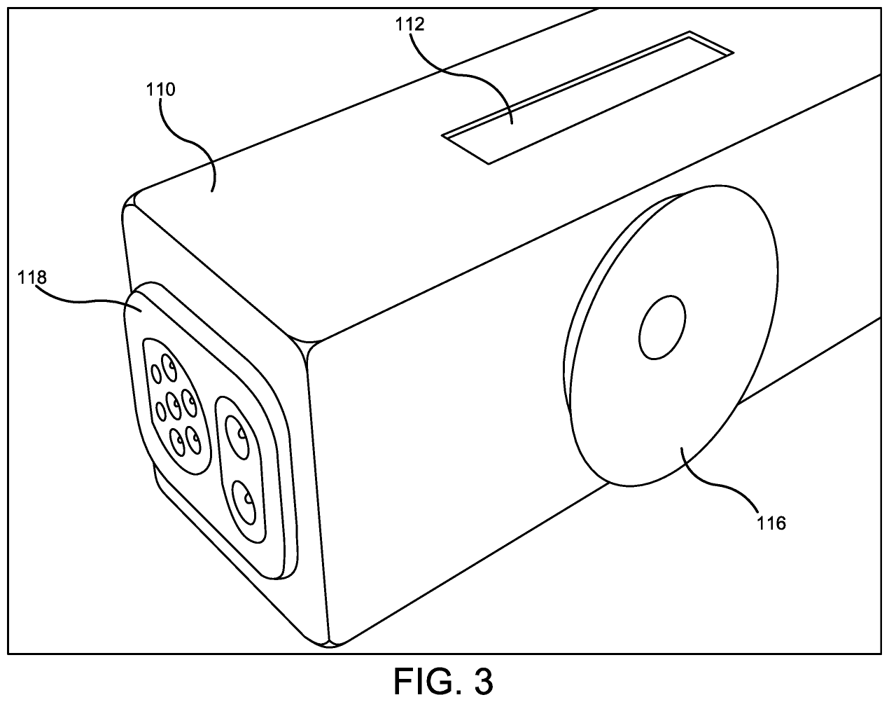

The handle 114 provides a grip for a user to grasp the device 100. The handle 114 may be of a differing material than the body 110, such as rubber, to provide better traction and may also be comprised of grooves that may contour with the fingers of a user. The fastener 116 allows the device 100 to attach to the side of an electric vehicle 10. The fastener 116 is preferably a suction cup, as seen in FIG. 3, to attach to the electric vehicle 10 while charging without damaging the vehicle body in any way. However, the fastener 116 may be any type known in the art that allows the device 100 to attach to the vehicle 10 exterior without damage.

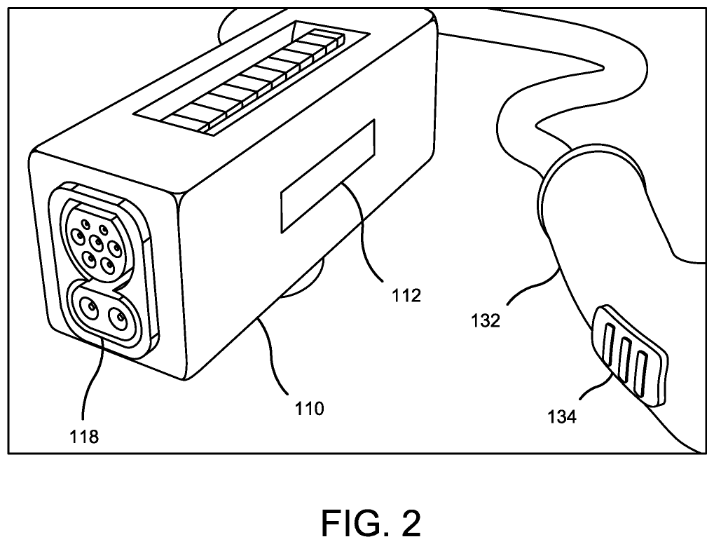

FIG. 2 illustrates a perspective view of one potential embodiment of an electric vehicle portable charger device 100 of the present invention in accordance with the disclosed architecture. The body 110 of the device 100 is also comprised of a female charging port 118 that allows at least one battery 120 encased inside of the body 110 to charge. The female charging port 118 may be any type of charging port or socket but is preferably a female charging port 118 used to charge an electric vehicle 10 such as, but not limited to, an AC Type 1 charging port, an AC Type 2 charging port, a DC CHAdeMo charging port, or a DC CCS charging port. The battery 120 may be any rechargeable battery in the form of an alkaline, nickel-cadmium, nickel-metal hydride battery, lithium-ion, lead-acid, etc., such as any 3V-12 volts DC battery or other conventional battery such as A, AA, AAA, etc., that supplies power to the device 100. Throughout this specification the term “battery” 120 may be used interchangeably to refer to one or more wet or dry cells or batteries of cells in which chemical energy is converted into electricity and used as a source of power. References to recharging or replacing the battery 120 may refer to recharging or replacing individual cells, individual batteries of cells, or a package of multiple battery cells as is appropriate for any given battery technology that may be used.

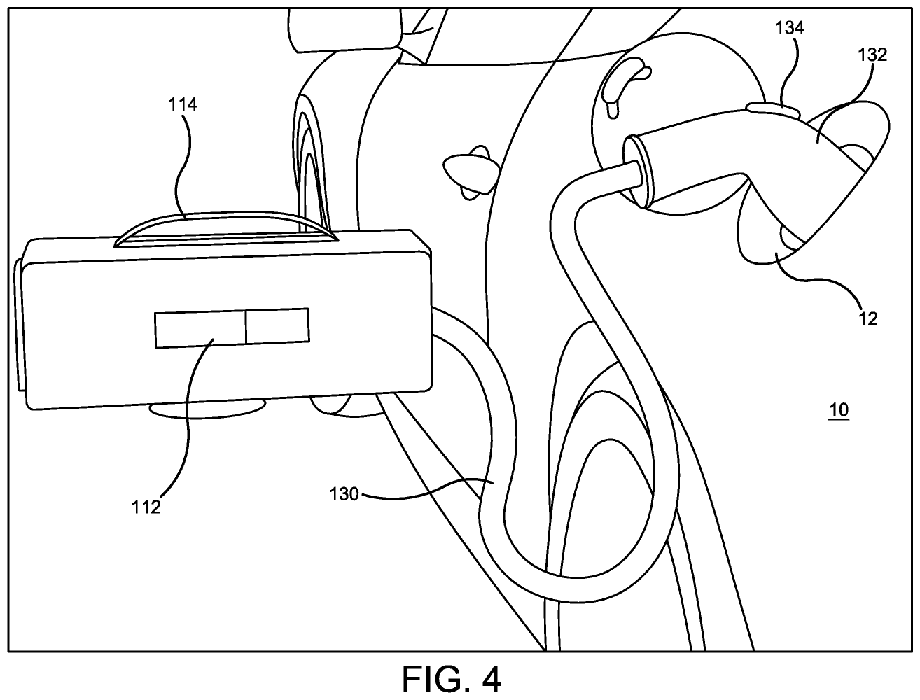

FIG. 4 illustrates a perspective view of one potential embodiment of an electric vehicle portable charger device 100 of the present invention while being used to charge an electric vehicle in accordance with the disclosed architecture. Extending from the body 110 of the device 100 is a charging cord 130 that is used to transfer power from the battery 120 to the charging port 12 of the electric vehicle 10 via the male charging port 136. The charging cord 130, in differing embodiments, may be of any length and may be coiled such that it can extend when needed, but takes up minimal space when being stored. Attached to the other end of the charging cord 130 is a charging handle 132. The charging handle 132 is comprised of at least one button 134 and a male charging port 136. The male charging port 136 may be any charging port used on an electric vehicle such that it may be accepted by, and power may be transferred from, the battery 120 to the electric vehicle 10. The male charging port 136 may be, but is not limited to, an AC Type 1 charging port, an AC Type 2 charging port, a DC CHAdeMo charging port, or a DC CCS charging port. Further, the button 134 of the charging handle 132 may be any type of button 134, such as one that is pushed in, tilted, slid forward/backwards, pulled up, etc. Once the charging handle 132 is inserted into the electric vehicle 10, the button 134 may be activated and charging will commence.

It should be noted that the battery 120 is in wired electrical communication with the female charging port 118 and the male charging port 136 is in wired electrical communication with the battery 120 via the charging cord 130.

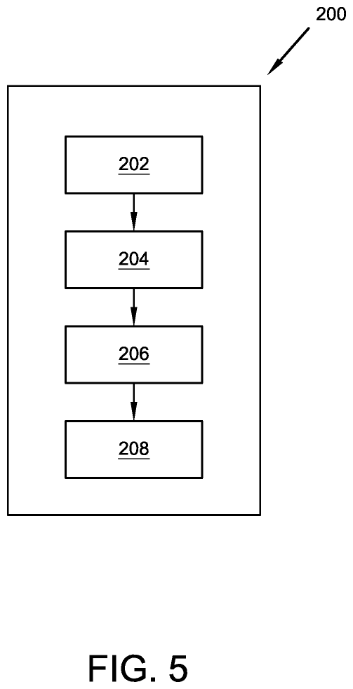

The present invention is also comprised of a method of using 200 the device 100, as seen in FIG. 5. First, a device 100 is provided comprised of a device 100 comprised of at least one female charging port 118, at least one battery 120, and at least one charging handle 132 with at least one male charging port 13 [Step 202]. Then, a user can charge the battery 120 of the device 100 by inserting a male EV charger into the female charging port 118 [Step 204]. Then, a user can attach the body 110 of the device 100 to an electric vehicle 10 via the fastener 11 [Step 206]. Next, a user can insert the male charging port 136 of the charging handle 132 into the charging port 12 of the vehicle 10 and press the button 134 to charge the vehicle 10 via the electrical power stored within the battery 120 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric vehicle portable charger device” and “device” are interchangeable and refer to the electric vehicle portable charger device 100 of the present invention.

Notwithstanding the foregoing, the electric vehicle portable charger device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the electric vehicle portable charger device 100 as shown in the FIGS. are for illustrative purposes only, and that many other sizes and shapes of the electric vehicle portable charger device 100 are well within the scope of the present disclosure. Although the dimensions of the electric vehicle portable charger device 100 are important design parameters for user convenience, the electric vehicle portable charger device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric vehicle portable charger device comprising:
a battery positioned within a body;
a charging cord;
a female charging port in electrical communication with the battery; and
a male charging port in electrical communication with the battery via the charging cord.

2. The electric vehicle portable charger device of claim 1, wherein the male charging port is positioned on a charging handle.

3. The electric vehicle portable charger device of claim 2, wherein the charging handle is comprised of a button.

4. The electric vehicle portable charger device of claim 1, wherein the female charging port is positioned on the body.

5. The electric vehicle portable charger device of claim 1 comprised of a handle positioned on the body.

6. The electric vehicle portable charger device of claim 1, wherein the male charging port is comprised of an AC Type 1 charging port, an AC Type 2 charging port, a DC CHAdeMo charging port, or a DC CCS charging port.

7. The electric vehicle portable charger device of claim 1, wherein the female charging port is comprised of an AC Type 1 charging port, an AC Type 2 charging port, a DC CHAdeMo charging port, or a DC CCS charging port.

8. An electric vehicle portable charger device comprising:
a battery positioned within a body;
a battery indicator;
a fastener;
a charging cord;
a female charging port in electrical communication with the battery;
a male charging port; and
a male charging port in electrical communication with the battery via the charging cord.

9. The electric vehicle portable charger device of claim 8, wherein the fastener is comprised of a suction cup.

10. The electric vehicle portable charger device of claim 8, wherein the fastener is positioned on the body.

11. The electric vehicle portable charger device of claim 8, wherein the battery indicator is comprised of a display screen.

12. The electric vehicle portable charger device of claim 11, wherein the display screen is comprised of an LED screen.

13. The electric vehicle portable charger device of claim 11, wherein the battery indicator displays a power amount of the battery.

14. The electric vehicle portable charger device of claim 8, wherein the male charging port is positioned on a charging handle.

15. The electric vehicle portable charger device of claim 14, wherein the charging handle is comprised of a button.

16. The electric vehicle portable charger device of claim 8, wherein the male charging port is comprised of an AC Type 1 charging port, an AC Type 2 charging port, a DC CHAdeMo charging port, or a DC CCS charging port.

17. The electric vehicle portable charger device of claim 8, wherein the female charging port is comprised of an AC Type 1 charging port, an AC Type 2 charging port, a DC CHAdeMo charging port, or a DC CCS charging port.

18. A method of using an electric vehicle portable charger device, the method comprising the steps of:
providing an electric vehicle portable charger device comprised of a female charging port, a battery, and a charging handle with a male charging port;
charging the battery by inserting a male electric vehicle charger into the female charging port;
attaching a body of the device to an electric vehicle via a fastener positioned on the body; and
inserting the male charging port of the charging handle into a charging port of an electric vehicle and pressing a button on the charging handle to charge the electric vehicle via power stored in the battery.

19. The method of claim 18, wherein the male charging port is comprised of an AC Type 1 charging port, an AC Type 2 charging port, a DC CHAdeMo charging port, or a DC CCS charging port.

20. The method of claim 18, wherein the female charging port is comprised of an AC Type 1 charging port, an AC Type 2 charging port, a DC CHAdeMo charging port, or a DC CCS charging port.
